(19) United States
(12) Patent Application Publication
(10) Pub. No.: US 2004/0015383 A1
(43) Pub. Date: Jan. 22, 2004

(54) Method, device and system for collecting, visualizing and/or modifying operating data of at least one machine pertaining to the tobacco processing industry

(76) Inventors: Andreas Rathjen, Hamburg (DE); Dirk Richter, Hamburg (DE); Uwe Marsau, Dassendorf (DE); Gunar Baatz, Norderstedt (DE); Marian-Georg Dancau, Heist (DE); Helge Frauen, Geesthacht (DE); Michael Straube, Hamburg (DE); Christian Junge, Hamburg (DE); Karsten Eckert, Hamburg (DE); Frank Grothaus, Hamburg (DE); Ralf Heikens, Hamburg (DE); Dierk Wedekind, Glinde (DE)

Correspondence Address: GREENBLUM & BERNSTEIN, P.L.C., 1950 ROLAND CLARKE PLACE, RESTON, VA, 20191, US

(21) Appl. No.: 10/362,966

(22) PCT Filed: Sep. 13, 2001
(86) PCT No.: PCT/EP01/10545

(30) Foreign Application Priority Data
Sep. 15, 2000 (DE) 100461336

(51) Int. Cl. G06F 17/60

(52) U.S. Cl. 705/8; 705/9

(57) ABSTRACT

The invention relates to a method and a system for collecting, visualising and/or modifying operating data of at least one machine (10) pertaining to the tobacco processing industry. The method involves calling up the operating data by at least one computer (14, 17-20), and a bus system (15, 16) is provided for the system and the device, by which means the operating data can be transferred between at least one control system (13) and at least one computer (14, 17). The inventive method is characterised in that at least some of the operating data is placed on a web server (18) and can be called up via the Internet (21, 31) and/or at least one intranet (16, 32) by at least one other computer (19, 20) which can be connected to the Internet (21, 31) and/or intranet (16, 32). The inventive device is characterised by a data connection (21) enabling at least some of the operating data to be collected, visualised and/or modified via the Internet (21, 31) and/or at least one intranet (16, 32).

The invention relates to a method for collecting, visualizing and/or modifying operating data of at least one machine, in particular of machines of the tobacco processing industry, whereby the operating data are accessed by at least one computer.

The invention further relates to a device and a system for collecting, visualizing and/or modifying operating data of at least one machine, in particular of machines of the tobacco processing industry, whereby a bus system is provided, by means of which operating data can be transferred between at least one control system and at least one computer.

Machines and installations in the tobacco industry are generally equipped with control and visualization systems. Existing data connections, such as in particular Ethernet data connections, make it possible to communicate with host computers in the factories of the tobacco-processing companies. These companies are hereinafter referred to as customers. This communication provides a way of, e.g., combining the production capacities of the individual machines and installations into one system or one device for factory control. Regular maintenance by the operators is necessary during the operation of the machines or installations of the tobacco industry, such as, e.g., installations for tobacco processing, production machines for the production of cigarettes or packaging machines for packaging cigarettes. Faults may occur in the sequence of operations which have to be eliminated.

The most suitable people for eliminating corresponding operational faults can often be found at the manufacturers of corresponding machines or installations of the tobacco industry. The same applies to the corresponding maintenance of such machines or installations. However, these people are often not on-site with the customer, but regularly have to travel to the machines or installations.

A method and a system for collecting operating data of machines is known from DE 198 31 867 A1, whereby the operating data are collected at the machine side. These operating data are accessed by a DDE server and made available to an application by the DDE server.

One object of the present invention is to provide a time-extensive way of maintaining and modifying operating data even of a running machine, in particular an installation or machine of the tobacco processing industry. Another object of the present invention is to reveal a way of displaying operating data of machines.

This object is attained by a method for collecting, visualizing and/or modifying operating data of at least one machine, in particular machines of the tobacco processing industry, whereby the operating data are accessed by at least one computer that is further developed in that at least a part of the accessed operating data is made available to a Web server and can be accessed via the Internet and/or intranet by at least one other computer that can be connected to the Internet and/or intranet.

Within the scope of this invention, the term Internet also includes the term intranet. As far as this term is concerned, it is particularly important that an open communication language or protocol, such as, e.g., Netbios, IPX/SPX (e.g., IEEE 802.2) or TCP/IP is used for communication. The operating data are accessed by a control computer and transferred to a Web server and can be accessed by a computer, in particular a Web client, that can be connected by means of Web technology. A Web authoring language, such as HTML or XML, can be used on the Web client and Web server.

The Web client can thereby be a program that runs on a computer that is connected to the Internet or an intranet, or a device that can be used as a Web client, e.g., a WAP mobile phone or a UMTS mobile phone. However, the Web client can also be a program that runs on the control computer of the machine and communicates with the Web server by means of Web technology. Likewise, the Web server can be a program that runs on a computer that is connected to the control computer of the machine. The Web server can also be a program that runs directly on the control computer of the machine.

In this case, only one computer is required, which carries out the three functions of control computer, Web server and Web client. In this case, the Web client meets the requirement of collecting, visualizing and/or modifying operating data. Communication between the Web server and the Web client and between the Web server and the control computer or control program is conducted in Web technology, e.g., TCP/IP. Communication between the Web client and the control computer is then also conducted with such a technology.

By means of the method according to the invention it is possible to collect and to visualize in particular the relevant operating data so that the operators who are not present at the customer's site can monitor the essential operating data easily and, if necessary, can give instructions to people present on-site by means of an appropriate means of communication. The person who is not on-site and is the respective expert for the corresponding machine or installation can be a person assigned to the customer or a person assigned to the manufacturer of the corresponding machine or installation.

The at least one computer that accesses the operating data and the one on which the Web server is installed can in particular preferably be identical. Within the scope of this invention a Web server means in particular a computer or a part of a computer that has provided at least one area that can be accessed via the Internet, so that data can be sent from and/or to the Web server via the Internet.

A particularly preferred embodiment of the present invention is if, in addition, the machine is controlled by modifying the operating data placed on the Web server. In this way the machine can be controlled from outside and in particular via the Internet. To this end the Web server provides the control computer with modified operating data that are transferred from the Web client to the Web server. The function of the machine can thus be controlled. When the Web client communicates with the Web server via the Internet or an intranet, a kind of remote control thus occurs.

Within the scope of this invention, machine of the tobacco processing industry means in particular a production machine for producing cigarettes, an installation for tobacco processing, a packaging machine for packaging cigarettes, several of these machines or installations or a system of such machines or installations that are coupled together. Within the scope of this invention operating data mean in particular production and process data.

A visualization of at least a part of the accessed operating data preferably occurs on the at least one other computer or on at least one Web client. The operating data respectively visualized accordingly thereby preferably represent in particular the data most essential for the operation of the machines.

Furthermore, the control and/or visualization preferably occur in real time. Within the scope of this invention, real time means in particular that the data are processed or displayed by the recipient at the rate at which they are transferred, i.e., there is no loss of data. This can be achieved by ascertaining the data rate of the transfer path and adjusting the data quantity accordingly. Priority in the selection is thereby given to the data that are expressly requested by the Web client or that relate to breakdowns that have occurred or are about to occur. By adjusting the data depth to the achievable data transfer rate, a Web client can provide the complete functionality of a conventional visualization computer, if an adequate transfer width is provided (e.g., client on control computer, broadband Internet or wireless Ethernet).

Through this preferred embodiment of the method according to the invention it is possible to intervene promptly in the operation of the corresponding machines. To this end communication paths are preferably used and in particular databases that are very fast.

When the operating data relevant to an operational fault and/or operational data selected by an operator preferably have priority for access, visualization and/or control, it is possible to ensure a control and/or visualization in real time even with a somewhat slower data connection.

Preferably at least part of the program responsible for controlling the machine runs on the Web server and control commands are sent to the machine and/or the control system. Through this preferred embodiment of the method according to the invention a decentralized monitoring and control of the machine or of corresponding machines is possible. Furthermore, an actualization of corresponding programs or control programs is possible in a very fast and cost-extensive manner, if in particular preferably several machines are controlled by a program on the Web server. In this case the Web server should preferably be reached by the customer or the customer's machine via the Internet, so that control commands are transmitted in particular preferably via the Internet.

When preferably at least a part of the program responsible for the control of the machine runs on the at least one other computer, and the control commands are sent via the Internet to the machine and/or control system, it is possible to realize a central control of several machines, which is operator- and maintenance-friendly and thus cost-effective.

The Web server is preferably arranged on a computer that is contained by the machine and by means of which operating data are communicated from a control system. When the Web server is also a component of the control system, a particularly fast process control is possible. When in addition the Web server communicates directly with actuators and sensors of the machine, a very fast and direct access to the operating data can occur.

The object is further attained according to the invention by a system for collecting, visualizing and/or modifying operating data of at least one machine of the tobacco processing industry, whereby a bus system is provided by means of which operating data can be transferred between at least one control system and at least one computer, which is further developed in that a data connection is provided, by means of which at least a part of the operating data can be collected, visualized and/or modified via the Internet and/or the intranet.

This system according to the invention renders possible an external collection, visualization and/or modification of the operating data by operator staff who do not first have to travel to the machine.

Preferably at least a part of the part of the operating data that can be collected, visualized and/or modified via the Internet can be collected, visualized and/or modified in real time. This measure according to the invention also makes it possible to render possible with a data connection the collection, visualization and modification of the essential operating data in real time. To this end priorities are preferably assigned to the operating data.

When preferably at least a part of the control system is physically arranged separate from the at least one machine through the Internet, control commands can be generated externally, which commands are sent to the machine via the Internet, so that if a control system of the machine is not working properly, even this can be replaced by a properly functioning control system that is arranged externally to the machine. The modification of the operating data via an intranet preferably has priority over the modification of operating data via the Internet. At least a part of the control system is also preferably arranged physically separate from the at least one machine through the Internet.

Preferably a permanent data connection between a Web server and the machine or the at least one computer that is in particular integrated into the machine, is provided. This connection can preferably be a fixed connection.

One preferred embodiment is when the Web server is arranged on a computer that is contained by the machine and by means of which a communication of operating data between the control system and the Web server is rendered possible at least indirectly. This preferred embodiment of the system according to the invention renders possible a system of compact construction. When the Web server is contained by the control system, a very fast communication of the operating data in the control system via the Web server is possible. When the Web server can also preferably be connected directly to actuators and sensors of the machine, a very direct and fast access to the actuators and sensors of the machine is rendered possible.

The object is further attained according to the invention by means of a device for collecting, visualizing and/or modifying operating data of at least one machine of the tobacco processing industry, whereby a bus system is provided, by means of which operating data can be transferred between at least one control system and at least one computer, which is further developed in that at least one data line is provided by means of which at least a part of the operating data can be transferred via the Internet and/or at least one intranet, so that it can be collected, visualized and/or modified via the Internet and/or the intranet.

Preferably at least a part of the part of the operating data that can be transferred via the Internet can be transferred in real time.

Furthermore, preferably at least a part of the control system is physically arranged separate from the at least one machine through the Internet. Furthermore, the modification of the operating data via an intranet preferably has priority over the modification of the operating data via the Internet. When, e.g., data are modified via the intranet, it is assumed that the people who modify the operating data are close to the machines. In this case, this operator is to be assigned a higher priority than an operator who wants to access the machine from a distance via the Internet. To this end it is sufficient to install an inhibit bit for the modification of operating data via the Internet. Inhibit bits are used to block access from the Internet when an operator is accessing via the intranet. It is also possible to assign priorities with different passwords.

The invention is described below by way of example without restriction of the general inventive concept on the basis of exemplary embodiments with reference to the drawings, to which reference is otherwise expressly made regarding inventive details not described in further detail in the text. They show:

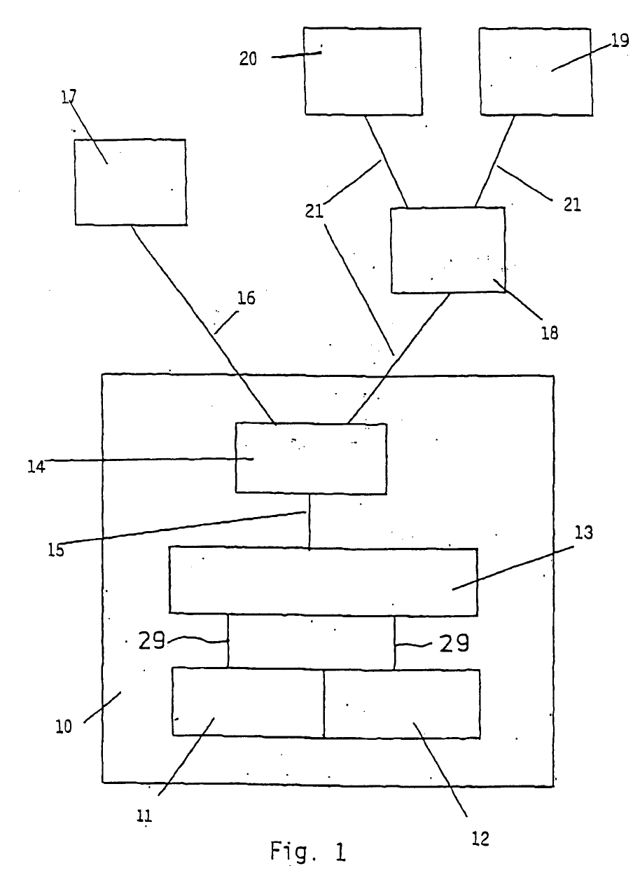

FIG. 1 A schematic block diagram representation of the system according to the invention or the device according to the invention,

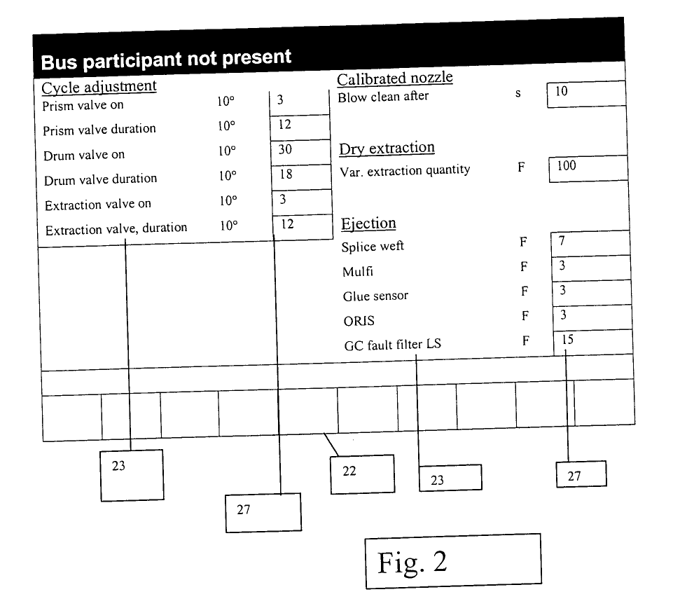

FIG. 2 An example of a visualization of operating data,

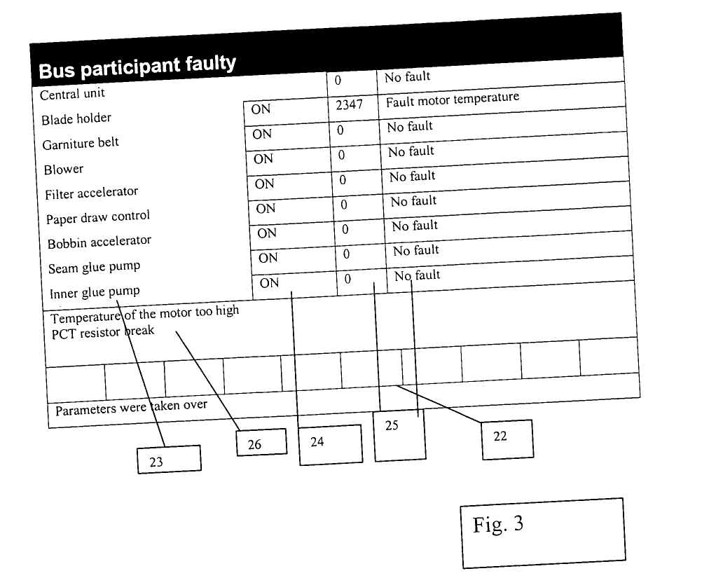

FIG. 3 Another example of a visualization of operating data,

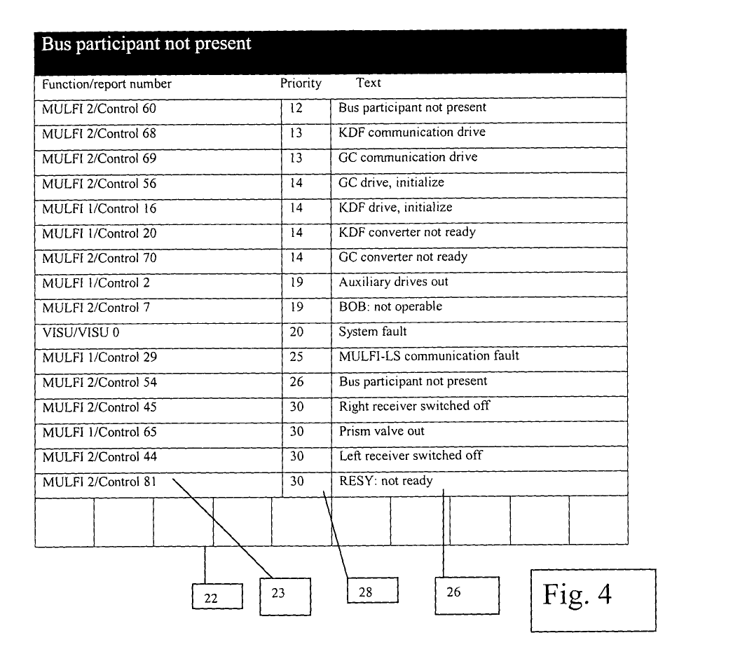

FIG. 4 A third example of a visualization of operating data, and

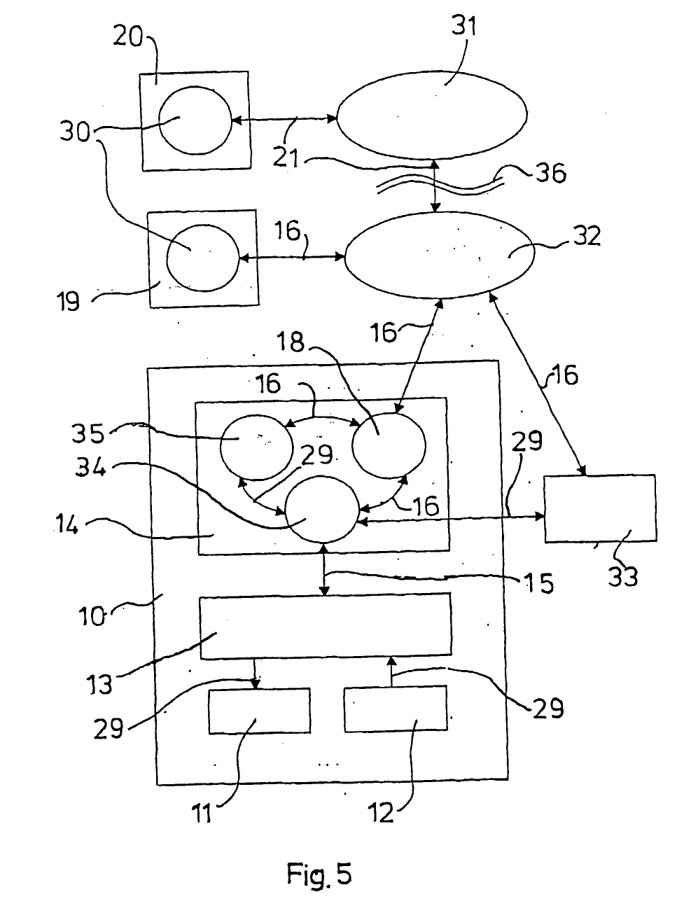

FIG. 5 Another schematic block diagram representation of a second system according to the invention or a second device according to the invention,

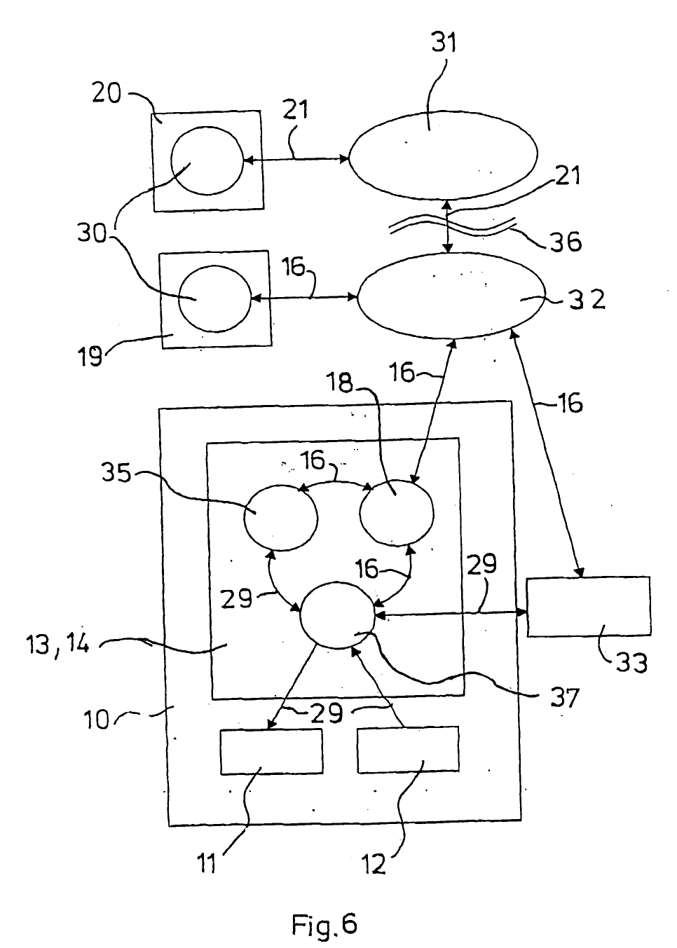

FIG. 6 Another schematic block diagram representation of a third system according to the invention or a third device according to the invention, and

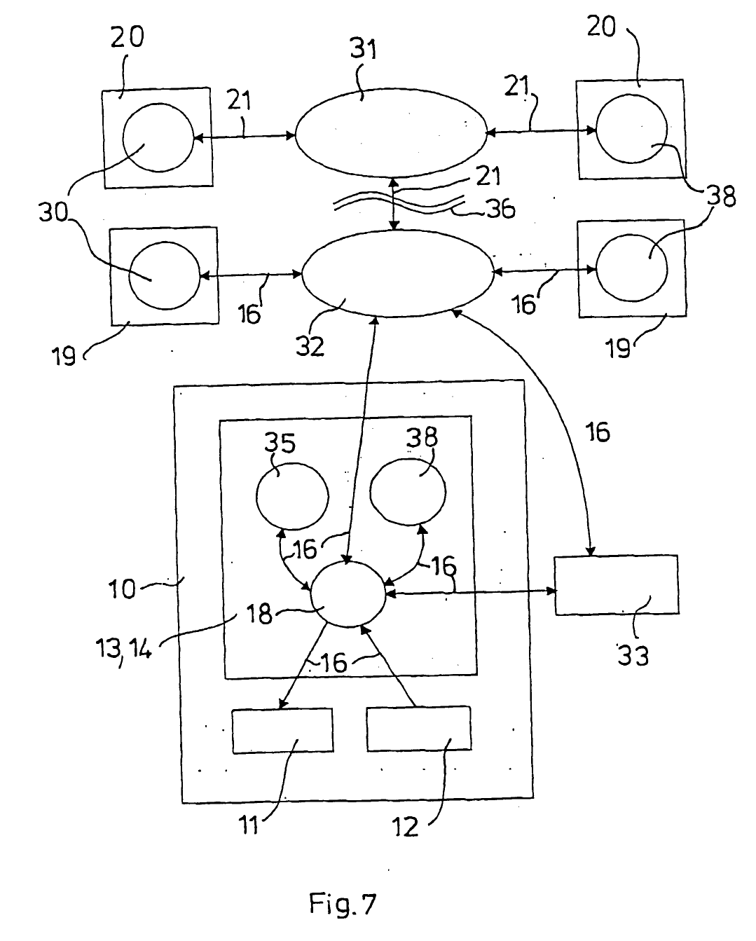

FIG. 7 A schematic block diagram representation of another system according to the invention or another device according to the invention.

FIG. 1 shows in a schematic block representation an exemplary embodiment of the system according to the invention or of the device according to the invention for collecting, visualizing and/or modifying operating data of a tobacco processing installation 10. The tobacco processing installation 10 comprises sensors 11 and actuators 12 that are connected to a control system 13. The measurement data of the sensors 11 are made available to the control system 13, whereas control signals from the control system 13 are sent to the actuators 12. The control system 13 is connected to a computer 14 via a Profibus 15. Instead of the Profibus 15, e.g., another known bus, such as an ISA bus or an MPI bus can also be used. The Profibus has a transfer rate of 12 MBaud.

The computer 14 can comprise, e.g., a computer program that renders possible the visualization of the operating data on-site. Furthermore, the computer 14 can comprise a software that renders possible a connection to a host computer 17 in the customer's factory. An intranet connection 16 can be used here which is made, e.g., via the Ethernet. Furthermore, the computer 14 can comprise a program and other elements, by means of which an Internet connection 21 is possible. A connection of the computer 14 to a Web server 18 can be possible by means of this Internet connection 21. The Internet connection is physically embodied by at least one data line.

As a preferred embodiment of this invention the computer 14 itself could be the Web server 18, or a part of the computer 14 could be the Web server 18. According to FIG. 1, data and in particular operating data can be transferred between a computer 19 at the manufacturer of the tobacco processing installation 10 and the Web server 18, and correspondingly also between the Web server 18 and a computer 20 at the customer's. Accordingly data and in particular operating data can be transferred between the Web server 18 and the computer 14 and thus also the control system 13. Moreover, data and in particular operating data can also be transferred via the intranet between the host computer 17 and the computer 14 and thus also the control system 13.

Through the system according to the invention and the device according to the invention it is possible to adjust production data, such as in particular the quantity of tobacco to be processed and the quantity of the tobacco to be sent to a machine for producing cigarettes. Furthermore, it is possible to transfer or adjust accordingly the rotational speeds and filling quantities of the corresponding installation or of a production machine for producing cigarettes (not shown in FIG. 1). Accordingly operating data of a cigarette packaging machine can also be visualized, collected and/or modified.

For example, the TestPoint software by Keithley or the Win CC WebNavigator program can be preferably used to visualize the operating data. A user-friendly process visualization and -operation is thus possible via the Internet. Within the scope of this invention visualization means not only the display of operating data on a monitor, but also the possibility of entering data, e.g., via a keyboard or a touch-sensitive monitor.

FIGS. 2, 3 and 4 should serve as examples of corresponding visualizations. These represent respectively an exemplary display on a monitor. A toolbar 22 is shown, by means of which one can, e.g., scroll through the pages of the visualization. Machine units such as, e.g., a prism valve, a drum valve or an extraction valve are shown in the unit field 23. Furthermore, e.g., as shown in FIG. 3, a central unit, a blade holder, the garniture belt, a blower, a filter accelerator, a paper draw control, a bobbin accelerator, a seam glue pump and an inner glue pump are shown in the unit field 23. Status field 24 shows whether the respective unit is switched on or off. Furthermore, a fault field 25 is shown in FIG. 3, in which both a number and a written description is provided. In FIG. 3 the number 2,347 is shown in fault field 25, which is assigned to the blade holder, which corresponds to a fault regarding the motor temperature. The corresponding fault is specified in more detail in the description field 26. Accordingly the temperature of the motor is too high or a PCT resistor break has occurred.

FIG. 2 also shows a parameter field 27, which represents the corresponding parameters for the above-mentioned units in the unit field 23. In the corresponding parameter fields 27 the parameters can be adjusted and the adjusted parameters sent to the corresponding machine. With corresponding problems it is possible for the constructing engineer or another operator to access the machine's visualization system via an Internet access and to read important information for a diagnosis of the fault and if necessary to modify operating data.

FIG. 3, e.g., shows the fault diagnosis report for the drive system of a production machine for producing cigarettes.

FIG. 4 shows, e.g., current fault messages in a description field 26, whereby the respective faults are assigned priorities in the priority field 28.

Furthermore, it is possible to follow the processing of the machine program via the system online. This also renders possible in particular a remote maintenance or remote operation of the corresponding machine. The corresponding machine is, e.g., a Protos 90 E, a KDF 3E/AF 3E (filter manufacturing machine) or a Chronos (packaging machine) of the applicant.

It is further possible to assign an Internet address containing a Web site to each operative unit. Using this address with its corresponding branches or links or secondary and main pages, it is possible to access data, parameters and operating conditions over great distances. If necessary, corresponding parameters for a variety of operating types of machines and installations can also be adjusted. Security mechanisms hereby organize the authorization and the access to sensitive machine data. The displayed and modifiable operating data are actualized in real time or modified in real time. To this end preferably the most important data are assigned a higher priority for transfer via the data lines, since the corresponding installations or machines in part require a fast response, which should be obvious with a production speed, e.g., of a cigarette in a cigarette producing machine in 6 ms.

The control system 13 represented in FIG. 1 is preferably removed in part to outside the machine or tobacco processing installation 10, namely to the host computer 17, the Web server 18 and/or one of the computers 19 or 20. It is thus possible to use a possibly higher computer power available there for controlling the corresponding machines.

Operating data can be production-related data, such as, e.g., the actual values or measured values of speeds (e.g., rod speeds, conveyor speeds, etc.), temperatures, pressures, rotational speeds, quantities, quality data, etc., machine-specific data in the form of set-point values of the above-mentioned variables and parameters of the drive systems, such as, e.g., reset times, position controller amplification, synchronous conditions, position deviation data, etc.

FIG. 5 shows another schematic block diagram representation of another system according to the invention or another device according to the invention. The computer 14 is specified in more detail in this Fig. with regard to software products or software units. A Web server 18 is realized in the form of software on the computer 14, which is connected to a visualization and input software 35 via intranet connections 16 and to a communication software 34, by means of which communication with the control system 13 is possible. The communication software 34 is connected to the visualization and input software 35 via a connection line 29 or a connection realized in terms of software. This connection 29 can also be realized in the form of an intranet connection 16, with which in particular communication can be made by means of the open programming language TCP/IP or another protocol mentioned above as an example. Furthermore, the communication software is connected via a connection line 29 to an otherwise conventional operating data collection system 33 in FIG. 5. These operating data collection systems 33 otherwise used with corresponding cigarette machines or corresponding machines of the tobacco processing industry can thus still be used in addition and used in particular for a very fast communication and a very fast control and collection of the operating data.

Both the operating data collection system 33 and the Web server 18 are connected to the intranet 32, which in FIG. 5 is shown only schematically. In fact, intranet 32 can also mean the other components and lines connected to the intranet, such as in particular those arranged in the computer 14. The intranet renders possible a connection to a computer 19 at the customer's on which a software of a Web client 30 is realized, by means of which a visualization and modification of operating data is possible. Accordingly, the intranet 32 is connected to the Internet 31 via an Internet connection 21. To this end a decoupling 36 is usually provided, such as, e.g., a firewall or an exclusive access via only one dialup number in order to prevent unauthorized persons accessing the intranet 32 from the Internet 31. A computer at the manufacturer's 20 can be connected via the Internet 31 by means of a data line 21, on which computer a Web client 30 runs on which data can also be visualized and modified or entered.

FIG. 6 shows another exemplary embodiment of the system according to the invention or the device according to the invention with which, in contrast to FIG. 5, the computer 14 is simultaneously a control system 13, so that the Web server 18 is provided as a subsidiary unit of the control system 13. In this exemplary embodiment a control software 37 is provided by means of which the data can be received and forwarded by the sensors 11 and by means of which actuators 12 can be controlled. Sensors 11 and actuators 12 can be connected to the computer 14 or the control software 37 with corresponding connection lines 29. In this exemplary embodiment the Web server directly accesses the control software, so that a very fast connection and control are possible. The operating data collection system 33 is also connected to the control software 37.

FIG. 7 shows a fourth exemplary embodiment of the system according to the invention or the device according to the invention. In this exemplary embodiment the programming work is considerably minimized, since all the components are programmed via a Web technology, and the software modules that on the computer 14 or the control system 13 can correspond to those that at a distance from the machine 10 can be connected to the machine 10 via the intranet or still further away can be connected to the machine via the Internet. In this exemplary embodiment the Web server 18 in the computer 14 or the control system 13 is directly connected to the actuators and sensors and furthermore in addition to the operating data collection system 33 as well. Intranet connections, i.e., in particular connections in the intranet data format, go from the Web server 18 to a visualization and input software 35 or a corresponding module and a control client 38. In this exemplary embodiment the visualization and input software 35 can also be embodied as a Web client 30. Corresponding Web clients 30 are also, as before, connected to the intranet or to the Internet, which then can feature a corresponding visualization and input software 35. Furthermore the control client 38 provided in the computer 14 or the control system 13, also correspondingly distant from the machine 10, can be connected to the intranet 32 and, still more distant from the machine 10 or, e.g., at the manufacturer's, can be connected to the Internet 31.

The exemplary embodiment according to FIG. 7 renders possible a very simple programming of the corresponding program modules. The exemplary embodiment according to FIG. 6 is relatively simple to program compared to the exemplary embodiments of the previous Figs., since there too a corresponding coordination of software modules can be established.

List of Reference Numbers

| | |
|---|---|
| 10 | Tobacco processing installation |
| 11 | Sensors |
| 12 | Actuators |
| 13 | Control system |
| 14 | Computer |
| 15 | Profibus |
| 16 | Intranet connection |
| 17 | Host computer |
| 18 | Web server |
| 19 | Computer at the customer's |
| 20 | Computer at the manufacturer's |
| 21 | Internet connection |
| 22 | Tool bar |
| 23 | Unit field |
| 24 | Status field |
| 25 | Fault field |
| 26 | Description field |
| 27 | Parameter field |
| 28 | Priority field |
| 29 | Connection line |
| 30 | Web client |
| 31 | Internet |
| 32 | Intranet |
| 33 | Operating data collection system |
| 34 | Communication software |
| 35 | Visualization and input software |
| 36 | Decoupling |
| 37 | Control software |
| 38 | Control client |

1. Method for collecting, visualizing and/or modifying operating data of at least one machine (10) of the tobacco processing industry, whereby the operating data are accessed by at least one computer (14, 17-20), characterized in that at least a part of the accessed operating data is made available to a Web server (18) and can be accessed via the Internet (21) and/or at least one intranet (16, 32) by at least one other computer (19, 20) and/or Web client (30) that can be connected to the Internet (21, 31) and/or the intranet (16, 32).

2. Method according to claim 1, characterized in that moreover the machine (10) is controlled by modifying the operating data made available on the Web server (18).

3. Method according to claim 1 and/or 2, characterized in that a visualization of at least a part of the accessed operating data occurs on the at least one other computer (18-20).

4. Method according to claim 2 and/or 3, characterized in that the control and/or visualization occur in real time.

5. Method according to one or more of claims 1 through 4, characterized in that the operating data relevant to an operational fault and/or operational data selected by an operator have priority for access, visualization and/or control.

6. Method according to one or more of claims 1 through 5, characterized in that at least a part of the program responsible for the control of the machine (10) runs on the Web server (18) and control commands are sent to the machine (10) or to the control system (13).

7. Method according to one or more of claims 1 through 5, characterized in that at least a part of the program responsible for the control of the machine (10) runs on the at least one other computer (18-20) and/or a Web client (30) and the control commands are sent via the Internet (21, 31) and/or the intranet (16, 32) to the machine (10) and/or the control system (13).

8. Method according to one or more of claims 1 through 7, characterized in that the Web server (18) is arranged on a computer (14) that is contained by the machine (10) and by means of which operating data are communicated from a control system (13).

9. Method according to one or more of claims 1 through 7, characterized in that the Web server (18) is a component of the control system (13).

10. Method according to claim 9, characterized in that the Web server (18) communicates directly with actuators (12) and sensors (11) of the machine (10).

11. System for collecting, visualizing and/or modifying operating data of at least one machine (10) of the tobacco processing industry, whereby a bus system (15, 16) is provided by means of which operating data can be transferred between at least one control system (13) and at least one computer (14, 17) and/or a Web client (30), characterized in that a data connection (21) is provided, by means of which at least a part of the operating data can be collected, visualized and/or modified via the Internet (21, 31) and/or the intranet (16, 32).

12. System according to claim 11, characterized in that at least a part of the part of the operating data that can be collected, visualized and/or modified via the Internet (21, 31) and/or the intranet (16, 32) can be collected, visualized and/or modified in real time.

13. System according to claim 11 and/or 12, characterized in that at least a part of the control system (13) is physically arranged separate from the at least one machine (10) through the Internet (21, 31) and/or the intranet (16, 32).

14. System according to one or more of claims 11 through 13, characterized in that the modification of the operating data via an intranet (16, 32) has priority over the modification of operating data via the Internet (21, 31).

15. System according to one or more of claims 11 through 14, characterized in that the Web server (18) is arranged on a computer (14) that is contained by the machine (10) and by means of which a communication of the operating data between the control system (13) and the Web server (18) is rendered possible at least indirectly.

16. System according to one or more of claims 11 through 13, characterized in that the Web server (18) is contained by the control system (13).

17. System according to claim 16, characterized in that the Web server (18) can be directly connected to actuators (12) and sensors (11) of the machine (10).

18. Device for collecting, visualizing and/or modifying operating data of at least one machine (10) of the tobacco processing industry, whereby a bus system (15, 16) is provided, by means of which operating data can be transferred between at least one control system (13) and at least one computer (14, 17), characterized in that at least one data line (21) is provided by means of which at least a part of the operating data can be transferred via the Internet (21, 31) and/or the intranet (16, 32), so that this part can be collected, visualized and/or modified via the Internet and/or the intranet.

19. Device according to claim 18, characterized in that at least a part of the part of the operating data that can be transferred via the Internet and/or the intranet can be transferred in real time.

20. Device according to claim 18 and/or 19, characterized in that at least a part of the control system (13) is physically arranged separate from the at least one machine (10) through the Internet and/or the intranet.

21. Device according to one or more of claims 18 through 20, characterized in that the modification of the operating data via an intranet (16) has priority over the modification of the operating data via the Internet.

22. Device according to one or more of claims 18 through 21, characterized in that the Web server (18) is arranged on a computer (14) that is contained by the machine (10) and by means of which a communication of the operating data between the control system (13) and the Web server (18) is rendered possible at least indirectly.

23. Device according to one or more of claims 18 through 21, characterized in that the Web server (18) is contained by the control system (13).

24. Device according to claim 23, characterized in that the Web server (18) can be directly connected to actuators (12) and sensors (11) of the machine (10).
